(19) United States
(12) Patent Application Publication
(10) Pub. No.: US 2016/0251962 A1
(43) Pub. Date: Sep. 1, 2016

(54) GAS TURBINE

(71) Applicant: MITSUBISHI HITACHI POWER SYSTEMS, LTD., Kanagawa (JP)

(72) Inventor: Shinya HASHIMOTO, Tokyo (JP)

(73) Assignee: MITSUBISHI HITACHI POWER SYSTEMS, LTD., Kanagawa (JP)

(21) Appl. No.: 15/028,121

(22) PCT Filed: Oct. 10, 2014
(86) PCT No.: PCT/JP2014/077262

§ 371 Date: Apr. 8, 2016

(30) Foreign Application Priority Data
Oct. 15, 2013 (JP) 2013-214972

(51) Int. Cl. F01D 5/08; F02C 7/18; F02C 9/18; F04D 29/32; F04D 29/54; F02C 3/04; F04D 29/52

(52) U.S. Cl. CPC F01D 5/081; F02C 3/04; F02C 7/18; F04D 29/522; F04D 29/324; F04D 29/542; F02C 9/18; F05D 2220/32; F05D 2240/35

(57) ABSTRACT

There is provided a gas turbine, in which a compressor is provided with: a compressor casing which forms a ring-shaped air path; a rotor; a plurality of blade bodies which are fixed on the outer circumference of the rotor and disposed in the air path; a plurality of vane bodies fixed on the compressor casing between the blade bodies and disposed in the air path; a cooling air flow passage provided so as to face the outer side of the plurality of blade bodies in the compressor casing; a first cooling air supply channel which supplies a part of compressed air to the cooling air flow passage; a cooler which cools the compressed air in the first cooling air supply channel; and a second cooling air supply channel which supplies the cooling air from the cooling air flow passage to a part to be cooled of a turbine.

### TECHNICAL FIELD

The present invention relates to, for example, a gas turbine in which fuel is supplied to and combusted in high-temperature high-pressure compressed air and the generated combustion gas is supplied to a turbine to produce rotary power.

### BACKGROUND ART

A common gas turbine is composed of a compressor, a combustor, and a turbine. The compressor compresses air taken in through an air inlet to turn the air into high-temperature high-pressure compressed air. The combustor supplies fuel to this compressed air and combusts the fuel to produce high-temperature high-pressure combustion gas. The turbine is driven by this combustion gas, and drives a generator which is coaxially coupled to the turbine.

The compressor of such a gas turbine has pluralities of vanes and blades installed inside a casing alternately along the air flow direction, and air taken in through the air inlet is compressed by passing through the pluralities of vanes and blades and turns into high-temperature high-pressure compressed air. Examples of such a gas turbine include the one described in Patent Literature 1.

### CITATION LIST

### Patent Literature

Patent Literature 1: Specification of U.S. Pat. No. 7,434,402

### SUMMARY OF INVENTION

### Technical Problems

In the compressor of the conventional gas turbine described above, for example, during hot start, a tip portion of each blade elongates toward the radially outer side as the blade rotates at a high speed, while an air path (blade ring) on the casing side contracts toward the inner side by being cooled with low-temperature air taken in. In this case, the clearance between the tip of the blade and the inner wall surface of the blade ring constituting the air path decreases temporarily. Thereafter, the blades and the blade ring are heated by high-temperature high-pressure compressed air and elongate. However, due to the difference in heat capacity between the blade and the blade ring, the clearance between the tip of the blade and the inner wall surface of the blade ring increases. For this reason, it is necessary to secure a predetermined or larger clearance between the tip of the blade and the inner wall surface of the blade ring immediately after hot start. Accordingly, the clearance between the tip of the blade and the inner wall surface of the blade ring during steady operation of the compressor, when the blades and the air path (blade ring) have reached high temperatures, becomes excessively large. Then, the compression efficiency of the compressor decreases, so that the performance of the gas turbine itself deteriorates.

In the compressor described in Patent Literature 1, a compressed thermal fluid is extracted and this thermal fluid is supplied to a flow passage of the blade ring and discharged to the turbine. However, even if the thermal fluid extracted from the compressor is directly supplied to the flow passage of the blade ring, it is difficult to sufficiently cool the blade ring.

Moreover, to respond to the trend of the increasing pressure and temperature of compressed air, it is necessary to suppress heat input from the compressed air from the viewpoint of reducing the clearance between the tip of the blade and the inner wall surface of the blade ring. However, Patent Literature 1 does not take into account this necessity.

Having been devised to solve the above problems, the present invention aims to provide a gas turbine in which a proper amount of clearance is secured between the casing and the blades to enhance the performance.

### Solution to Problems

A gas turbine of the present invention for achieving the above object includes: a compressor which compresses air; a combustor which mixes compressed air compressed by the compressor and fuel and combusts the fuel; a turbine which produces rotary power from combustion gas generated by the combustor; and a rotating shaft which is driven by the air to rotate around a rotation axis, wherein the compressor includes: a casing which forms an air path having a ring shape around the rotation axis; a plurality of blade bodies which are fixed on the outer circumference of the rotating shaft at predetermined intervals in the axial direction and disposed in the air path; a plurality of vane bodies which are fixed on the casing between the plurality of blade bodies and disposed in the air path; a blade ring which is provided so as to face the radially outer side of the plurality of blade bodies and on the inside of which a cooling air flow passage is formed; a first cooling air supply channel which supplies a part of the compressed air compressed by the compressor to the cooling air flow passage; and a second cooling air supply channel which supplies the cooling air from the cooling air flow passage to a part to be cooled of the turbine.

Accordingly, a part of the compressed air is extracted from the compressor, and the extracted compressed air is cooled by a cooler, supplied through the first cooling air supply channel to the cooling air flow passage of the casing, and supplied through the second cooling air supply channel to the part to be cooled of the turbine. Therefore, as the outer side of the plurality of blade bodies in the casing is cooled by the cooling air, these portions of the blade bodies do not shift significantly under the heat from the compressed air. Thus, it is possible to suppress deterioration of the compression performance of the compressor and enhance the gas turbine performance by securing a proper amount of clearance between the casing and the blade.

In the gas turbine of the present invention, the blade ring includes an isolation ring which is supported from the blade ring through a support part, which is protruding toward the radially inner side, of the blade ring and forms a ring shape around the rotation axis, and the isolation ring has a collar which supports the vane body through an outer shroud of the vane body.

Accordingly, heat input from the air path side into the blade ring is significantly reduced, so that temperature rise of the blade ring can be suppressed.

In the gas turbine of the present invention, the cooling air flow passage has a plurality of manifolds which are disposed at predetermined intervals in an air flow direction in the air path, and coupling paths which couple the plurality of manifolds in series.

Accordingly, as cooling air flows among the plurality of manifolds through the coupling paths inside the casing, the outer portions of the plurality of blade bodies in the casing can be cooled efficiently.

In the gas turbine of the present invention, the plurality of manifolds include a first manifold to which the first cooling air supply channel is coupled, a second manifold disposed on the upstream side in the air flow direction in the air path, and a third manifold which is disposed on the downstream side in the air flow direction in the air path and to which the second cooling air supply channel is coupled; and the coupling paths include a first coupling path which couples the first manifold and the second manifold with each other, and a second coupling path which couples the second manifold and the third manifold with each other.

Accordingly, the cooling air having been supplied through the first cooling air supply channel to the first manifold is supplied through the second coupling path to the second manifold and supplied through the second coupling path to the third manifold before being discharged through the second cooling air supply channel. Thus, it is possible to efficiently cool the outer portions of the plurality of blade bodies in the casing by securing a long path of the cooling air.

In the gas turbine of the present invention, the casing has the blade ring which has a cylindrical shape, forms the air path, and supports the outer circumference of the plurality of vane bodies, and the cooling air flow passage is formed as a cavity inside the blade ring.

Accordingly, the blade ring is provided at a position facing the plurality of blade bodies in the casing, and the cooling air flow passage is formed as a cavity inside the blade ring. Thus, the cooling air flow passage can be easily formed.

In the gas turbine of the present invention, the isolation ring is divided into a plurality of parts in the circumferential direction with a certain clearance provided therebetween.

Accordingly, since the isolation ring is divided into a plurality of parts in the circumferential direction with a certain clearance provided therebetween, the radial shift of the isolation ring is suppressed and does not affect the radial shift of the blade ring.

In the gas turbine of the present invention, the isolation ring forms a ring shape around the rotation axis, and is fixed on the inner circumference of the blade ring further on the downstream side in a flow direction of the compressed air in the air path than the plurality of blade bodies and the plurality of vane bodies.

Accordingly, heat input from the compressed air, which has passed through the blade bodies and the vane bodies, into the blade ring can be effectively blocked by the isolation ring.

### Advantageous Effects of Invention

According to the gas turbine of the present invention, since the cooling air flow passage is provided so as to face the outer side of the plurality of blade bodies in the casing, the outer portions of the plurality of blade bodies in the casing do not shift significantly by being cooled with cooling air. Thus, it is possible to suppress deterioration of the compression performance of the compressor and enhance the gas turbine performance by securing a proper amount of clearance between the casing and the blade.

Moreover, since the isolation ring is disposed on the inner circumferential side of the blade ring to reduce heat input from the air path side, it is possible to suppress temperature rise of the cooling air supplied to the part to be cooled of the turbine and prevent deterioration of the gas turbine performance.

### BRIEF DESCRIPTION OF DRAWINGS

FIG. 1 is a cross-sectional view showing the vicinity of a combustor in a gas turbine of an embodiment.

FIG. 2 is a cross-sectional view showing the vicinity of a blade ring of a compressor.

FIG. 3 is a cross-sectional view along the line of FIG. 2 showing a cross-section of the blade ring.

FIG. 4 is a cross-sectional view showing the vicinity of an isolation ring.

FIG. 5 is a graph showing the behavior of a clearance between constituent members of the compressor during hot start of the gas turbine.

FIG. 6 is a graph showing the behavior of the clearance between the constituent members of the compressor during cold start of the gas turbine.

FIG. 7 is a schematic view showing the overall configuration of the gas turbine.

### DESCRIPTION OF EMBODIMENT

In the following, a preferred embodiment of a gas turbine according to the present invention will be described in detail with reference to the accompanying drawings. The present invention is not limited by this embodiment, and if there are a plurality of embodiments, the present invention also includes configurations which combine the embodiments.

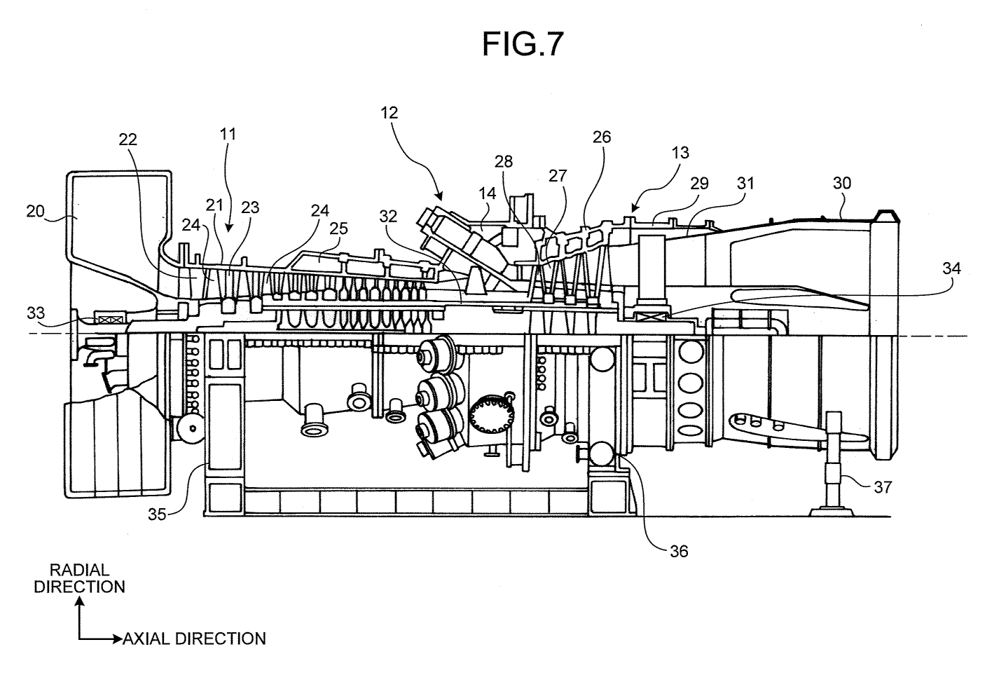

FIG. 7 is a schematic view showing the overall configuration of the gas turbine of this embodiment.

As shown in FIG. 7, the gas turbine of this embodiment is composed of a compressor 11, combustors 12, and a turbine 13. This gas turbine can generate electric power with a generator (not shown) coaxially coupled thereto.

The compressor 11 has an air inlet 20 through which air is taken in. Inside a compressor casing 21, an inlet guide vane (IGV) 22 is installed and a plurality of vanes 23 and a plurality of blades 24 are installed alternately in the air flow direction (the axial direction of a rotor 32 to be described later), and a bleed air chamber 25 is provided on the outer side of the compressor casing 21. This compressor 11 compresses air taken in through the air inlet 20 to produce high-temperature high-pressure compressed air and supplies the air to a casing 14.

The combustor 12 supplies fuel to the high-temperature high-pressure compressed air, which has been compressed in the compressor 11 and stored in the casing 14, and combusts the fuel to generate combustion gas. The turbine 13 has a plurality of vanes 27 and a plurality of blades 28 installed alternately in the flow direction of the combustion gas (the axial direction of the rotor 32 to be described later) inside a turbine casing 26. On the downstream side of this turbine casing 26, an exhaust chamber 30 is installed through an exhaust casing 29, and the exhaust chamber 30 has an exhaust diffuser 31 coupled to the turbine 13. This turbine is driven by the combustion gas from the combustor 12, and drives the generator coaxially coupled to the turbine.

The rotor (rotating shaft) 32 is disposed through the compressor 11, the combustors 12, and the turbine 13 so as to penetrate a center part of the exhaust chamber 30. One end of the rotor 32 on the side of the compressor 11 is rotatably supported by a bearing 33, and the other end on the side of the exhaust chamber 30 is rotatably supported by a bearing 34. In the compressor 11, a plurality of discs each having the blades 24 mounted thereon are stacked and fixed on the rotor 32. In the turbine 13, a plurality of discs each having the blades 28 mounted thereon are stacked and fixed on the rotor 32, and the driving shaft of the generator is coupled to the end of the rotor 32 on the side of the exhaust chamber 30.

In this gas turbine, the compressor casing 21 of the compressor 11 is supported by a leg 35, the turbine casing 26 of the turbine 13 is supported by a leg 36, and the exhaust chamber 30 is supported by a leg 37.

Accordingly, in the compressor 11, air taken in through the air inlet 20 is compressed by passing through the inlet guide vane 22 and the pluralities of vanes 23 and blades 24 and turns into high-temperature high-pressure compressed air. In the combustor 12, a predetermined fuel is supplied to and combusted in this compressed air. In the turbine, high-temperature high-pressure combustion gas generated in the combustor 12 passes through the pluralities of vanes 27 and blades 28 of the turbine 13 and thereby drives the rotor 32 to rotate, which in turn drives the generator coupled to the rotor 32. Meanwhile, the combustion gas is released into the atmosphere after its kinetic energy is converted into pressure by the exhaust diffuser 31 of the exhaust chamber 30 and the speed is reduced.

In the gas turbine thus configured, the clearance between the tip of each blade 24 and the compressor casing 21 in the compressor 11 is a clearance which takes into account thermal elongation of the blades 24, the compressor casing 21, etc., and it is desirable that the clearance between the tip of each blade 24 and the side of the compressor casing 21 in the compressor 11 is as small as possible from the viewpoint of a decrease in compression efficiency of the compressor 11 and ultimately of performance deterioration of the gas turbine itself.

In this embodiment, therefore, the initial clearance between the tip of the blade 24 and the side of the compressor casing 21 is increased and the side of the compressor casing 21 is properly cooled, so that the clearance between the tip of the blade 24 and the side of the compressor casing 21 during steady operation can be reduced to prevent a decrease in compression efficiency of the compressor 11.

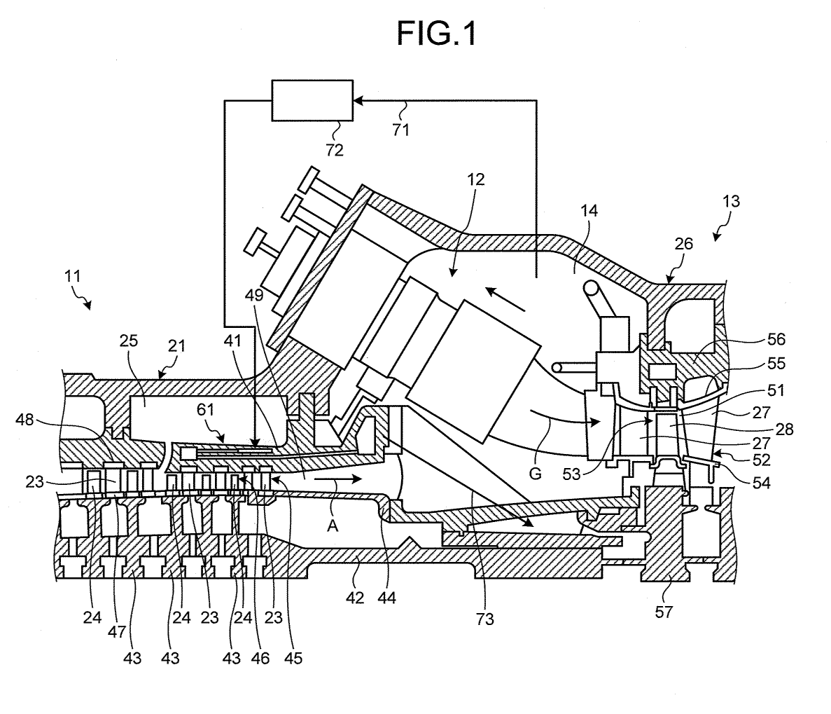

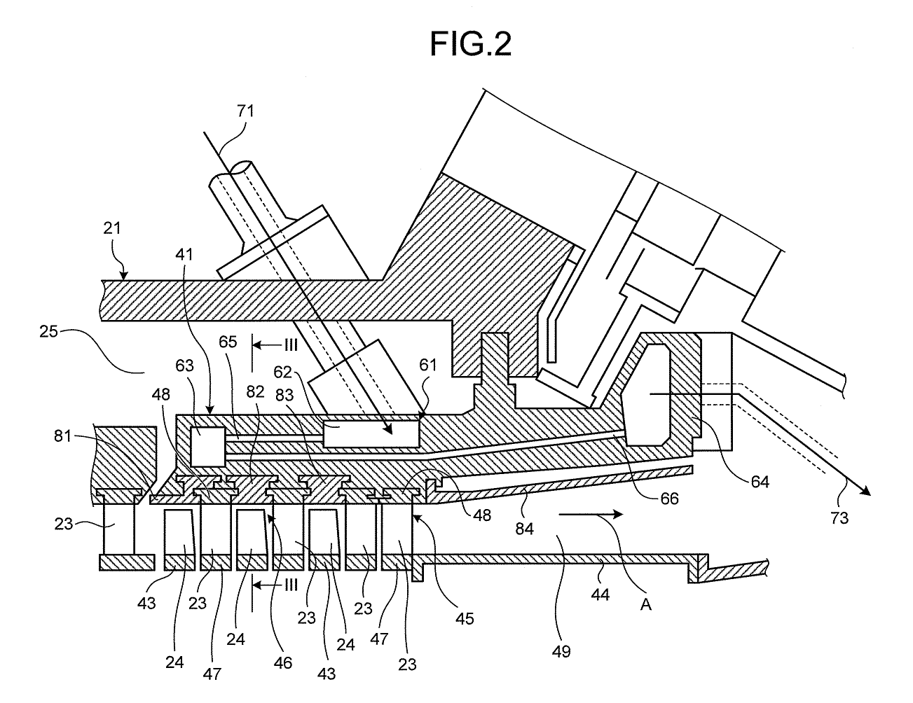

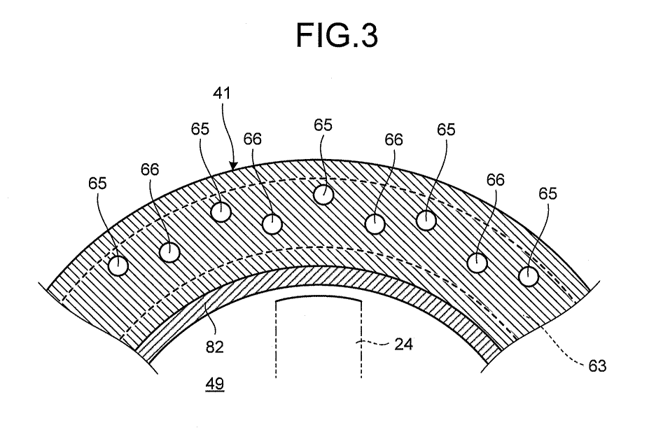

FIG. 1 is a cross-sectional view showing the vicinity of the combustor in the gas turbine of this embodiment; FIG. 2 is a cross-sectional view showing the vicinity of a blade ring of the compressor; and FIG. 3 is a cross-sectional view along the line of FIG. 2 showing a cross-section of the blade ring.

In the compressor 11, the casing of the present invention is composed of the compressor casing 21 and a blade ring 41 as shown in FIG. 1. In the compressor casing 21, which forms a cylindrical shape around a rotation axis C of the rotor 32, the blade ring 41 forming a cylindrical shape is fixed on the inner side of the compressor casing 21, so that the bleed air chamber 25 is formed between the compressor casing 21 and the blade ring 41. The rotor 32 (see FIG. 7) has a plurality of discs 43 integrally coupled on the outer circumference thereof, and is rotatably supported on the compressor casing 21 through the bearing 33 (see FIG. 7).

A plurality of vane bodies 45 and a plurality of blade bodies 46 are installed on the inner side of the blade ring 41, alternately along the flow direction of compressed air A. The vane bodies 45 have the plurality of vanes 23 disposed at regular intervals in the circumferential direction. The base end of the vane 23 on the side of the rotor 32 is fixed on a ring-shaped inner shroud 47, and the leading end of the vane 23 on the side of the blade ring 41 is fixed on a ring-shaped outer shroud 48. The vane bodies 45 are supported on the blade ring 41 through the outer shroud 48.

The blade bodies 46 have the plurality of blades 24 disposed at regular intervals in the circumferential direction. The base end of the blade 24 is fixed on the outer circumference of the disc 43, and the leading end of the blade 24 is disposed so as to face the inner circumferential surface of the blade ring 41. In this case, a predetermined clearance is secured between the tip of each blade 24 and the inner circumferential surface of the blade ring 41.

The compressor 11 has a ring-shaped air path 49 formed between the blade ring 41 and the inner shroud 47, and the plurality of vane bodies 45 and the plurality of blade bodies 46 are installed in this air path 49, alternately along the flow direction of the compressed air A.

The plurality of combustors 12 are disposed on the outer side of the rotor 32 at predetermined intervals along the circumferential direction, and are supported on the turbine casing 26. These combustors 12 supply fuel to the high-temperature high-pressure compressed air A, which has been compressed in the compressor 11 and sent from the air path 49 to the casing 14, and combust the fuel to generate the combustion gas (exhaust gas) G.

In the turbine 13, a gas path 51 is formed by the turbine casing 26. In this gas path 51, a plurality of vane bodies 52 and a plurality of blade bodies 53 are installed alternately along the flow direction of the combustion gas G. The vane bodies 52 have the plurality of vanes 27 disposed at regular intervals in the circumferential direction. The base end of the vane 27 on the side of the rotor 32 is fixed on a ring-shaped inner shroud 54, and the leading end of the vane 27 on the side of the turbine casing 26 is fixed on a ring-shaped outer shroud 55. The vane bodies 52 have the outer shroud 55 supported on a blade ring 56 of the turbine casing 26.

The blade bodies 53 have the plurality of blades 28 disposed at intervals in the circumferential direction. The base end of the blade 28 is fixed on the outer circumference of a disc 57 fixed on the rotor 32, and the leading end of the blade 28 is extended toward the side of the blade ring 56. In this case, a predetermined clearance is secured between the tip of each blade 28 and the inner circumferential surface of the blade ring 56.

As shown in FIG. 1 and FIG. 2, the compressor 11 is provided with a cooling air flow passage 61 on the inner circumferential surface side of the blade ring 41 so as to face the leading end of the plurality of blade bodies 46 (blades 24) in the blade ring 41. This cooling air flow passage 61 is formed as a cavity inside the blade ring 41.

The cooling air flow passage 61 has a plurality of (in this embodiment, three) manifolds 62, 63, 64 which are disposed at predetermined intervals along the flow direction of the compressed air A in the air path 49, and coupling paths 65, 66 which couple these plurality of manifolds 62, 63, 64 in series.

Specifically, the first manifold 62 which is formed at an intermediate position in the flow direction of the compressed air A in the air path 49 of the blade ring 41, the second manifold 63 disposed on the upstream side in the flow direction of the compressed air A in the air path 49 of the blade ring 41, and the third manifold 64 disposed on the downstream side in the flow direction of the compressed air A in the air path 49 of the blade ring 41 are provided as the cooling air flow passage 61. The first manifold 62 and the second manifold 63 are coupled with each other through the first coupling paths 65, and the second manifold 63 and the third manifold 64 are coupled with each other by the second coupling paths 66.

In this case, as shown in FIG. 3, the manifolds 62, 63, 64 are each formed as a cavity having a ring shape around the rotation axis C of the rotor 32 inside the blade ring 41. The plurality of first coupling paths 65, which couple the first manifold 62 and the second manifold 63 with each other, are formed on the outer circumferential side of the blade ring 41 at predetermined intervals in the circumferential direction. The plurality of second coupling paths 66, which couple the second manifold 63 and the third manifold 64 with each other, are formed further on the inner circumferential side of the blade ring 41 than the first coupling paths 65, at predetermined intervals in the circumferential direction. While these first coupling paths 65 and the second coupling paths 66 are disposed in a staggered manner with an offset in the circumferential direction, these coupling paths may be disposed at the same positions in the circumferential direction.

As shown in FIG. 1 and FIG. 2, the compressor 11 is provided with a first cooling air supply channel 71 which extracts a part of the compressed air A compressed by the compressor 11 from the casing 14 and supplies the air to the cooling air flow passage 61, a cooler 72 which cools the compressed air in the first cooling air supply channel 71, and a second cooling air supply channel 73 which supplies the cooling air from the cooling air flow passage 61 to a part to be cooled of the turbine 13.

The first cooling air supply channel 71 has the base end coupled to the casing 14 and the leading end coupled to the first manifold 62 of the cooling air flow passage 61. The cooler 72 is provided in the first cooling air supply channel 71 and can cool a part of the compressed air A. The second cooling air supply channel 73 has the base end coupled to the third manifold 64 and the leading end coupled to the part to be cooled of the turbine 13. Here, the part to be cooled of the turbine 13 is, for example, the blade 28 of the turbine 13, and a cooling path is formed from the disc 57 toward the blade 28, so that the compressed air A having cooled the blade ring 41 can be supplied from the third manifold 64 through the second cooling air supply channel 73 to this cooling path

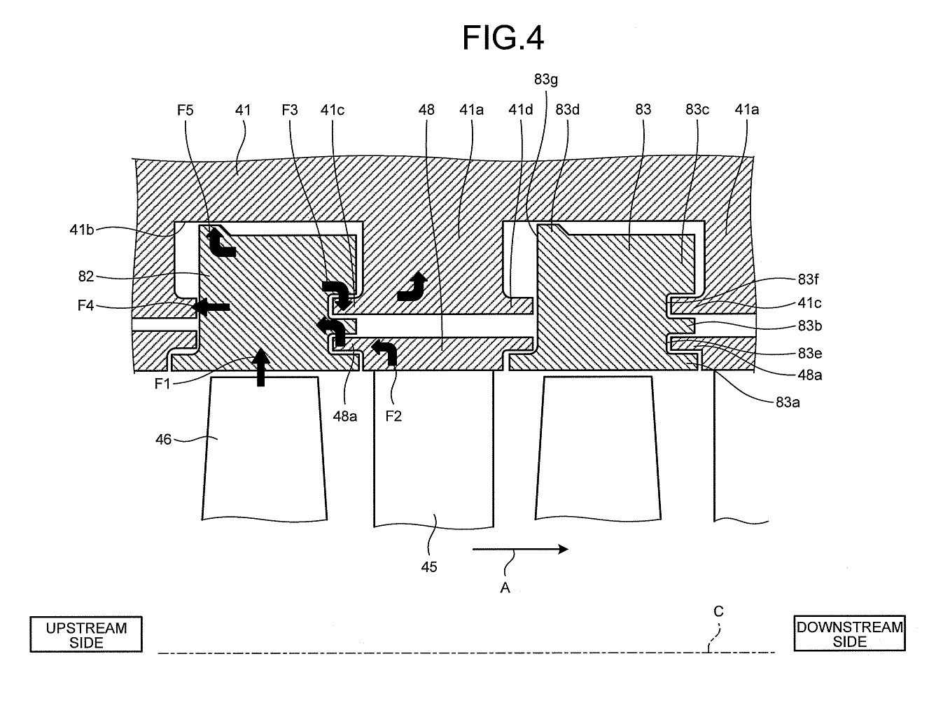

Next, the structure for blocking heat input from the side of the air path 49 into the blade ring 41 of the compressor 11 will be described with reference to FIG. 4. FIG. 4 shows, as an example, isolation rings 82, 83 which are disposed in a plurality of rows so as to face the axial positions of the vane bodies 45 and the blade bodies 46 which are arranged in a plurality of rows in the axial direction. The flow direction of the compressed air A is indicated by the arrow. In the following, the structure of the isolation ring will be described mainly in terms of the isolation ring 83.

A support part 41a, which protrudes toward the radially inner side and is formed in a ring shape around the rotation axis C, is formed on the radially inner circumferential side of the blade ring 41. An upstream edge 41c and a downstream edge 41d, protruding respectively toward the upstream side and the downstream side in the flow direction of the compressed air A, are formed at the radially inner end of the support part 41a, and the support part 41a is disposed so as to face the outer shroud 48 of each vane body 45. A blade ring groove 41b, which is formed so as to be recessed toward the radially outer side, is formed between the support member 41a disposed on the upstream side and the downstream side in the axial direction.

The isolation rings 82, 83, which are formed in a ring shape around the rotation axis C and divided into a plurality of parts in the circumferential direction, are disposed with a certain clearance in the blade ring groove 41b. On the downstream-side surface in the axial direction of the isolation ring 83, an isolation ring collar 83a is disposed which is formed at the radially inner terminal end and protrudes toward the upstream side and the downstream side in the axial direction. Moreover, on this downstream-side surface, a fixing portion 83b which is disposed further on the radially outer side than the isolation ring collar 83a and protrudes toward the axially downstream side, and a side wall protrusion 83c which is disposed further on the radially outer side than the fixing portion 83b in parallel to the fixing portion 83b and protrudes toward the axially downstream side are formed. Furthermore, a lower groove 83e, which is formed so as to be recessed toward the axially upstream side, is formed between the isolation ring collar 83a and the fixing portion 83b, and an upper groove 83f, which is recessed toward the axially upstream side and disposed in parallel to the lower groove 83e, is formed between the side wall protrusion 83c and the fixing portion 83b. At the axially upstream end of the outer circumferential surface of the isolation ring 83 on the radially outer side, an upper protrusion 83d protruding toward the radially outer side is formed in a ring shape around the rotation axis C so as to face the inner circumferential surface of the blade ring groove 41. The isolation ring 82 has the same shape.

At the radially outer end of the outer shroud 48 of the vane body 45, a shroud collar 48a is formed which protrudes toward the upstream side and the downstream side in the axial direction.

As the blade ring 41 has the above-described structure, the upstream edge 41c of the support part 41a is inserted into the upper groove 83f of the isolation ring from the axially downstream side. Moreover, the isolation ring 83 is thus supported from the blade ring 41 through the upstream edge 41c of the support part 41a, the side wall protrusion 83c, and the fixing portion 83b. The shroud collar 48a of the vane body 45 is inserted into the lower groove 83e of the isolation ring 83 from the downstream side toward the upstream side in the axial direction, and the vane body 45 is thus supported from the isolation ring 83 through the shroud collar 48a, the isolation ring collar 83a, and the fixing portion 83b.

In the case of normal operation, the vane bodies 45 are subjected to a reaction force oriented in the direction from the downstream side toward the upstream side in the axial direction (the direction from the right side toward the left side in the sheet of FIG. 4). As a result, the outer shroud 48 of the vane bodies 45 comes into contact with the lower groove 83e of the isolation ring 83 through the upstream-side end of the shroud collar 48a, pressing the isolation ring 83 toward the axially upstream side. On the other hand, the shroud collar 48a of the vane bodies 45 is inserted into the lower groove 83e formed between the fixing portion 83b and the isolation ring collar 83a, so that the vane bodies 45 are restrained from moving in the radial direction. Similarly, the upstream edge 41c of the support part 41a is inserted into the upper groove 83f formed between the fixing portion 83b and the side wall protrusion 83c, so that the isolation ring 83 is restrained from moving in the radial direction.

Due to the above-described structure and restraining conditions, on the axially downstream side, the isolation ring 83 comes into contact with the radially outer circumferential surface of the upstream edge 41c of the support part 41a through the inner circumferential surface of the side wall protrusion 83c on the radially inner side. On the axially upstream side, an upstream-side wall 83g in the axial direction of the isolation ring 83 comes into contact with the downstream edge 41d of the support part 41a. On the radially outer side, the upper protrusion 83d of the isolation ring 83 comes into contact with the blade ring groove 41b. That is, during normal operation, the isolation ring comes into contact with the blade ring only at the above-mentioned three locations (the upstream edge 41c, the downstream edge 41d, the upper protrusion 83d), and the isolation ring does not come into contact with the entire inner circumferential surface of the blade ring groove 41b, nor with the inner wall of the blade ring groove 41b on the upstream side or the downstream side in the axial direction.

The outer shroud 48 of the vane body 45 comes into contact with the isolation ring 83 only through the shroud collar 48a extending on the upstream side and the downstream side of the outer shroud 48 and the isolation ring collar 83a of the isolation ring 83, and does not come into direct contact with the blade ring 41. While the isolation ring 83 has been mainly described above, the isolation ring 82 has the same structure. For the reference signs of the portions of the isolation ring 82, for example, the isolation ring collar 83a of the isolation ring 83 should be read as an isolation ring 82a.

Next, with the isolation ring 82 taken as an example, heat migration from the compressed air A flowing through the air path 49 to the blade ring 41 will be described. As described above, heat migration from the compressed air A flowing through the air path 49 to the blade ring 41 is limited to heat input from the contact part between the blade ring 41 and the isolation ring 82. The heat migration from the side of the air path 49 shown in FIG. 4 is indicated by the arrows F1, F2, F3, F4. The heat input into the blade ring 41 includes the heat input F1 due to heat transfer from the inner circumferential surface of the isolation ring 82 facing the side of the air path 49, and the heat input F2 due to heat conduction from the vane body 45. The heat F1, F2 having been input into the isolation ring 82 escape through the contact part between the blade ring 41 and the isolation ring 82 into the blade ring 41. That is, there are only three types of heat inputs: the first heat F3 which migrates to the support part 41a of the blade ring 41 through the inner circumferential end (upper groove 820 of a side wall protrusion 82c and the upstream edge 41c of the support part 41a, the second heat F4 which migrates to the blade ring 41 from an upstream-side wall 82g of the isolation ring 82 through the downstream edge 41d of the support part 41a, and the third heat F5 which migrates to the blade ring 41 through the upper protrusion 83d. While the isolation ring 82 has been described here as an example, the same description applies to the other isolation rings as well.

Owing to the above structure, during gas turbine operation, a part of the compressed air A compressed by the compressor 11 is extracted from the casing 14, cooled in the cooler 72 provided in the first cooling air supply channel 71, and then supplied to the cooing air flow passage 61. That is, in the blade ring 41, the low-temperature compressed air A is supplied to the first manifold 62, supplied through the first coupling paths 65 to the second manifold 63, and supplied through the second coupling paths 66 to the third manifold 64. Thus, the blade ring 41 is cooled by the cooling air circulated inside, and prevented from reaching a high temperature. Thereafter, the cooling air having cooled the blade ring 41 is supplied from the third manifold 64 through the second cooling air supply channel 73 to the part to be cooled of the turbine 13. In this cooling air flow passage 61, since the path cross-sectional area of each of the coupling paths 65, 66 is smaller than the path cross-sectional area of each of the manifolds 62, 63, 64, the cooling air increases in flow velocity while passing through the coupling paths 65, 66, so that the blade ring 41 is cooled effectively.

Moreover, since the blade ring 41 is provided with the isolation rings 81, 82, 83, 84 on the side of the air path 49, heat input from the high-temperature high-pressure compressed air passing through the air path 49 can be significantly reduced.

The isolation rings 81, 82, 83, 84 are each divided into a plurality of parts in the circumferential direction and disposed in a ring shape around the rotation axis C with a certain clearance provided therebetween. Thus, since a certain clearance is provided in the circumferential direction, even if the isolation rings 81, 82, 83, 84 elongate in the circumferential direction due to heat input from the side of the air path 49, the elongation in the circumferential direction is absorbed by the clearance. Accordingly, almost no shift of the isolation rings toward the radially outer side occurs, so that the radial shift of the blade ring 41 is not affected.

Here, the radial shift of the constituent members of the compressor 11 during start of the gas turbine will be described.

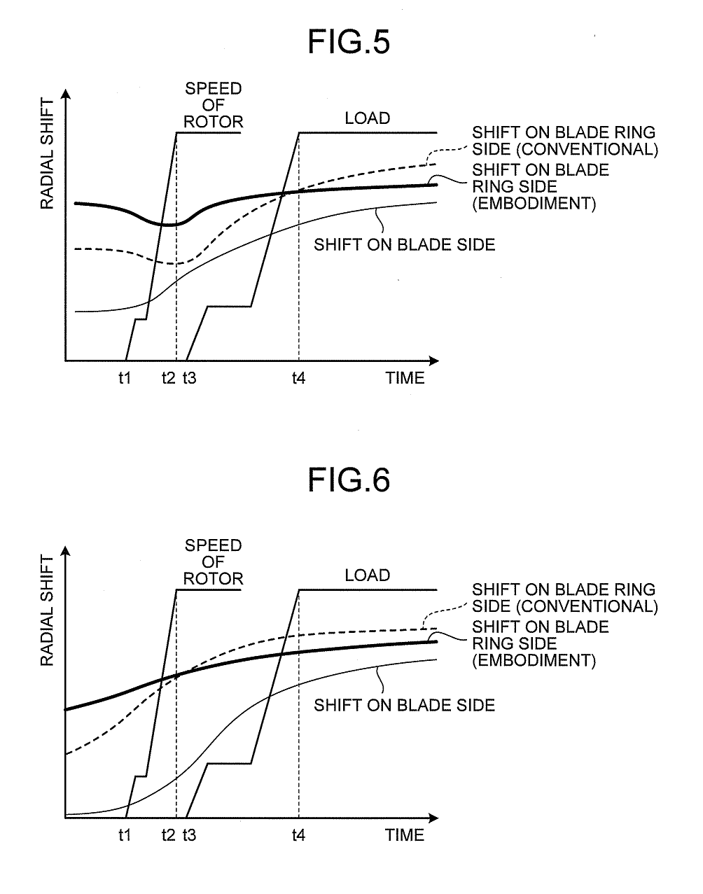

FIG. 5 is a graph showing the behavior of the clearance between the constituent members of the compressor during hot start of the gas turbine, and FIG. 6 is a graph showing the behavior of the clearance between the constituent members of the compressor during cold start of the gas turbine.

In the hot start of the conventional gas turbine, as shown in FIG. 1 and FIG. 5, if the gas turbine is started at time t1, the speed of the rotor 32 increases, and the speed of the rotor 32 reaches a rated speed at time t2 and is maintained constantly. Meanwhile, the compressor 11 takes in air through the air inlet 20, and as the air is compressed by passing through the pluralities of vanes 23 and blades 24, high-temperature high-pressure compressed air is generated. The combustor 12 is ignited before the speed of the rotor 32 reaches the rated speed, and supplies fuel to the compressed air and combusts the fuel to generate high-temperature high-pressure combustion gas. In the turbine 13, the combustion gas passes through the pluralities of vanes 27 and blades 28 and thereby drives the rotor 32 to rotate. As a result, the load (output) of the gas turbine increases at time t3, and reaches a rated load (rated output) at time t4 and the load is maintained constantly.

During such hot start of the gas turbine, the blades 24 shift (elongate) toward the radially outer side as they rotate at a high speed, and then further shift (elongate) toward the outer side by being subjected to heat from the high-temperature high-pressure compressed air passing through the air path 49. On the other hand, while the blade ring 41 is at a high temperature immediately after stop, for a certain time immediately after start of the gas turbine, low-temperature bleed air is supplied from the compressor 11 to the blade ring 41, and the blade ring 41 is cooled temporarily. As a result, the blade ring 41 temporarily shifts (contracts) toward the radially inner side, and then, as the temperature of the bleed air from the compressor 11 rises and the cooling effect of the bleed air on the blade ring 41 diminishes, the blade ring 41 shifts (elongates) again toward the outer side.

In this case, in the conventional gas turbine, the blade ring 41 as indicated by the dashed line in FIG. 5 shifts toward the inner side by being cooled with the low-temperature air at time t2, so that a pinch point occurs at which the clearance between the tip of the blade and the inner circumferential surface of the blade ring temporarily significantly decreases. Thereafter, the blade ring is heated by the high-temperature high-pressure compressed air and shifts (elongates) toward the outer side. Then, during rated operation after time t4, as the blade ring shifts significantly toward the outer side, the clearance between the tip of the blade and the inner circumferential surface of the blade ring increases excessively.

By contrast, in the gas turbine of this embodiment, although the blade ring 41 as indicated by the solid line in FIG. 5 shifts toward the inner side by being cooled with low-temperature air at time t2, the clearance between the tip of the blade 24 and the inner circumferential surface of the blade ring 41 does not decrease so much as in the conventional structure, since a large clearance is secured between the tip of the blade 24 and the inner circumferential surfaces of the blade ring 41 before start of the gas turbine. Then, during rated operation after time t4, the blade ring 41 is cooled by cooling air supplied to the cooling air flow passage 61, while heat input from the high-temperature high-pressure compressed air of the air path 49 is suppressed by the isolation rings 81, 82, 83, 84. As a result, although the blade ring 41 shifts slightly toward the outer side, the clearance between the tip of the blade 24 and the inner circumferential surfaces of the blade ring 41 does not become so large as in the conventional structure.

As shown in FIG. 1 and FIG. 6, during cold start of the gas turbine, since the blade ring 41 does not shift toward the radially inner side compared with during hot start, the pinch point is even less likely to occur than during hot start.

Thus, the gas turbine of this embodiment has the compressor 11, the combustors 12, and the turbine 13. The compressor 11 is provided with the compressor casing 21 which forms the ring-shaped air path 49, the rotor 32 rotatably supported in a center part of the compressor casing 21, the plurality of blade bodies 46 fixed on the outer circumference of the rotor 32 at predetermined intervals in the axial direction and disposed in the air path 49, the plurality of vane bodies 45 which are fixed on the compressor casing 21 between the plurality of blade bodies 46 and disposed in the air path 49, the blade ring 41 which is provided so as to face the outer side of the plurality of blade bodies 46 in the compressor casing 21 and on the inside of which the cooling air flow passage 61 is formed, the first cooling air supply channel 71 which supplies a part of the compressed air A to the cooling air flow passage 61, the cooler 72 which cools the compressed air A in the first cooling air supply channel 71, and the second cooling air supply channel 73 which supplies the cooling air from the cooling air flow passage 61 to the part to be cooled of the turbine 13.

Accordingly, a part of the compressed air is extracted from the compressor 11, and the extracted compressed air is cooled by the cooler 72, supplied through the first cooling air supply channel 71 to the cooling air flow passage 61 of the compressor casing 21, and then supplied through the second cooling air supply channel 73 to the part to be cooled of the turbine 13. Thus, as the outer side of the plurality of blade bodies 46 in the compressor casing 21 is cooled by the cooling air, these portions of the blade bodies 46 do not significantly shift under heat. It is therefore possible to suppress deterioration of the compression performance of the compressor 11 and enhance the gas turbine performance by maintaining a proper amount of clearance between the compressor casing 21 and the blade 24.

Since the compressed air A compressed by the compressor 11 is cooled by the cooler 72 before being supplied to the cooling air flow passage 61, the inner circumferential surface of the compressor casing 21 located on the outer side of the air path 49 can be cooled efficiently. Then, the cooling air having cooled the inner circumferential surface of the compressor casing 21 is used by being supplied to the part to be cooled of the turbine 13, so that the cooling air can be used efficiently.

In the gas turbine of this embodiment, as the cooling air flow passage 61, the plurality of manifolds 62, 63, 64 which are disposed at predetermined intervals in the air flow direction in the air path 49, and the coupling paths 65, 66 which couple these manifolds 62, 63, 64 in series are provided. Accordingly, as cooling air flows among the plurality of manifolds 62, 63, 64 through the coupling paths 65, 66 inside the compressor casing 21, the outer portions of the plurality of blade bodies 46 in the compressor casing 21 can be cooled efficiently.

In the gas turbine of this embodiment, the first manifold 62 to which the first cooling air supply channel 71 is coupled, the second manifold 63 disposed on the upstream side in the air flow direction in the air path 49, and the third manifold 63 which is disposed on the downstream side in the air flow direction in the air path 49 and to which the second cooling air supply channel 73 is coupled are provided, and the first manifold 62 and the second manifold 63 are coupled with each other through the first coupling paths 65, while the second manifold 63 and the third manifold 64 are coupled with each other through the second coupling paths 66. Accordingly, the cooling air supplied through the first cooling air supply channel 71 to the first manifold 62 is supplied through the second coupling paths 65 to the second manifold 63, supplied through the second coupling paths 66 to the third manifold 64, and discharged through the second cooling air supply channel 73. Thus, the cooling air flows inside the blade ring 41 in the reverse direction from the compressed air A and then flows in the same direction as the compressed air A. It is possible to efficiently cool the outer portions of the plurality of blade bodies 46 in the compressor casing 21 by securing a long path of the cooling air.

In the gas turbine of this embodiment, the blade ring 41 which has a cylindrical shape, forms the air path 49, and supports the outer circumference of the plurality of vane bodies 45 is provided as the compressor casing 21, and the cooling air flow passage 61 is formed as a cavity inside the blade ring 41. Thus, it is easy to form the cooling air flow passage 61, as it only requires machining the blade ring 41 without affecting the entire configuration of the compressor casing 21.

In the gas turbine of this embodiment, the isolation rings 81, 82, 83, 84 having a small contact area with the blade ring groove are provided on the surface of the blade ring 41 facing the side of the air path 49. Accordingly, when the high-temperature high-pressure compressed air A passes through the air path 49, heat input from the compressed air A into the blade ring 41 is blocked by the isolation rings 81, 82, 83, 84, so that the heat input into the blade ring is significantly reduced, which makes it possible to suppress temperature rise of the blade ring and suppress radial shift of the blade ring.

In the gas turbine of this embodiment, the isolation rings 81, 82, 83 are fixed on the inner circumference of the blade ring 41 which has a ring shape and faces the outer circumferential side of the plurality of blade bodies 46. Accordingly, heat input from the compressed air A into the inner circumferential surface of the blade ring 41 facing the blades 24 can be effectively blocked by the isolation rings 81, 82, 83.

In the gas turbine of this embodiment, the ring-shaped isolation ring 84 is fixed on the inner circumference of the blade ring 41 further on the downstream side in the flow direction of the compressed air A in the air path 49 than the plurality of blade bodies 46 and the plurality of vane bodies 45. Accordingly, heat input from the compressed air A, which has passed through the blade bodies 46 and the vane bodies 45, into the inner circumferential surface of the blade ring 41 can be effectively blocked by the isolation ring 84.

In the above embodiment, the cooling air flow passage 61 is configured by forming the plurality of manifolds 62, 63, 64 and the plurality of coupling paths 65, 66 in the blade ring 41, but the configuration is not limited to this example. That is, the shapes, the numbers, the positions of formation, etc. of the manifolds 62, 63, 64 can be set appropriately according to the shapes and the positions of the blade 24 and the blade ring 41.

### REFERENCE SIGNS LIST

11 Compressor
12 Combustor
13 Turbine
14 Casing
21 Compressor casing
23 Vane
24 Blade
32 Rotor (rotating shaft)
41 Blade ring
41a Support part
45 Vane body
48 Outer shroud
48a Shroud collar (collar)
46 Blade body
49 Air path
61 Cooling air flow passage
62 First manifold
63 Second manifold
64 Third manifold
65 First coupling path
66 Second coupling path
71 First cooling air supply channel
72 Cooler
73 Second cooling air supply channel
81, 82, 83, 84 Isolation ring
C Rotation axis

1. A gas turbine comprising:
a compressor which compresses air;
a combustor which mixes compressed air compressed by the compressor and fuel and combusts the fuel;
a turbine which produces rotary power from combustion gas generated by the combustor; and
a rotating shaft which is driven by the air to rotate around a rotation axis, wherein
the compressor includes:
a casing which forms an air path having a ring shape around the rotation axis;
a plurality of blade bodies which are fixed on the outer circumference of the rotating shaft at predetermined intervals in the axial direction and disposed in the air path;
a plurality of vane bodies which are fixed on the casing between the plurality of blade bodies and disposed in the air path;
a blade ring which is provided so as to face the radially outer side of the plurality of blade bodies and on the inside of which a cooling air flow passage is formed;
a first cooling air supply channel which supplies a part of the compressed air compressed by the compressor to the cooling air flow passage; and
a second cooling air supply channel which supplies the cooling air from the cooling air flow passage to a part to be cooled of the turbine; and
a plurality of isolation rings which are supported by the blade ring through a support part, which is protruding toward the radially inner side, of the blade ring, forms a ring shape around the rotation axis and supports the vane bodies through a collar protruding toward the axial direction at the radially inner terminal.

2. The gas turbine according to claim 1, wherein
the collar supports the vane body through an outer shroud of the vane body.

3. The gas turbine according to claim 1, wherein the cooling air flow passage has a plurality of manifolds which are disposed at predetermined intervals in an air flow direction in the air path, and coupling paths which couple the plurality of manifolds in series.

4. The gas turbine according to claim 3, wherein
the plurality of manifolds have a first manifold to which the first cooling air supply channel is coupled, a second manifold disposed on the upstream side in the air flow direction in the air path, and a third manifold which is disposed on the downstream side in the air flow direction in the air path and to which the second cooling air supply channel is coupled, and
the coupling paths have a first coupling path which couples the first manifold and the second manifold with each other, and a second coupling path which couples the second manifold and the third manifold with each other.

5. The gas turbine according to claim 1, wherein the casing has the blade ring which has a cylindrical shape, forms the air path, and supports the outer circumference of the plurality of vane bodies, and the cooling air flow passage is formed as a cavity inside the blade ring.

6. The gas turbine according to claim 2, wherein the isolation ring is divided into a plurality of parts in the circumferential direction with a certain clearance provided therebetween.

7. The gas turbine according to claim 2, wherein the isolation ring forms a ring shape around the rotation axis, and is fixed on the inner circumference of the blade ring further on the downstream side in a flow direction of the compressed air in the air path than the plurality of blade bodies and the plurality of vane bodies.
